(19) United States
(12) Patent Application Publication
(10) Pub. No.: US 2004/0094008 A1
(43) Pub. Date: May 20, 2004

(54) Cutting device

(76) Inventor: Toshio Tada, Nagaoka (JP)

Correspondence Address: McDermott Will & Emery, 600 13th Street NW, Washington, DC, 20005-3096, US

(21) Appl. No.: 10/471,842

(22) PCT Filed: Feb. 21, 2002
(86) PCT No.: PCT/JP02/01578

(30) Foreign Application Priority Data
Mar. 30, 2001 (JP) 2001-98091

(51) Int. Cl. B26D 5/08

(52) U.S. Cl. 83/556; 83/694

(57) ABSTRACT

The cutting apparatus according to the present invention is adapted to cut off with a pair of cutting members a part to be cut off of each lateral seal portion of series-connected packaged bags in which packaged bags containing a material sealed therein by heat sealing a packaging film are continuously formed, the cutting members being formed of a rotatably provided rotary blade, and a receiving blade provided so as to face the rotary blade, the receiving blade being provided with a transfer mechanism adapted to be moved forward and rearward synchronously with a rotation of the rotary blade. Therefore, the series-connected packaged bags can be transferred with the portions swollen due to a packed material of the bags not contacting the receiving blade. This enables the cutting apparatus to transfer the series-connected packaged bags stably without hurting the packaging film. Moreover, since the pulsation, which occurs due to the contact of the swollen portion with the receiving blade, of the series-connected packaged bags does not occur. Accordingly, a cutting apparatus capable of transferring series-connected packaged bags stably, and cutting off a part to be cut off of each lateral seal portion of the bags accurately can be provided.

### BACKGROUND OF THE INVENTION

1. Field of the Invention

This invention relates to a cutting apparatus capable of cutting off seal portions of a plurality of packaged bags continuously formed of, for example, a belt-like packaging material.

2. Description of the Related Art

There is a related art packaging machine for manufacturing packaged bags by, for example, folding one elongated packaging film in two and laminating the two parts of the twofold film on each other, or laminating two elongated films on each other; forming longitudinal seal portions on the laminated packaging film or films by longitudinally sealing both side edge portions thereof; forming a lateral seal portion (joint seal portion), which constitutes a bottom portion of a bag, on the laminated packaging film or films by laterally sealing a forward end portion thereof; filling an upper opened cylindrical portion of the packaging film or films, which is behind the lateral seal portion thereof with respect to the film transfer direction, with a predetermined quantity of material to be packaged; thereafter forming a lateral seal portion again on the portion of the packaging film or films which is rearwardly away from the previously-mentioned lateral seal portion by a predetermined distance; thereby forming packaged bags (which will hereinafter be referred to as series-connected packaged bags) continuously; and then cutting off each lateral seal portion, which are formed on the series-connected packaged bags, with a blade-carrying cutting apparatus.

The cutting apparatuses for this kind of packaging machine have a cutting mechanism made of a rotary blade, and a receiving blade provided so as to be opposed to the rotary blade as disclosed in, for example, JP-61-12324-Y2 and JP-6-171623-A. Such cutting apparatuses are adapted to position the blades in an opposed state on both sides of a substantially central section of a lateral seal portion of continuously transferred series-connected packaged bags, and then perforate (partially cut) the lateral seal portion, or cut off a substantially central section thereof.

In such packaging machines as described above, series-connected packaged bags are transferred in a considerably thickened state due to a material packed in each thereof. However, especially, in the case of series-connected packaged bags each of which is filled with a large quantity of material, each bag necessarily contacts the receiving blade, which is provided in a cutting position, every time the thickened portion of each of the packaged bags passes the cutting position, so that pulsation occurs in the series-connected packaged bags. Therefore, there is the possibility that the series-connected packaged bags slip at the lateral seal portions thereof or get hurt on the contacting portions thereof.

Especially, every time series-connected packaged bags filled with a large quantity of material and having a large thickness contact the receiving blade, pulsation occurs in the bags. When the series-connected packaged bags left in such an unstable condition are cut off at each lateral seal portion thereof, for example, a cut line or perforations become diagonal.

### SUMMARY OF THE INVENTION

The present invention has been made in view of these problems, and provides a cutting apparatus capable of transferring series-connected packaged bags stably and cutting off the same bags accurately.

The present invention provides a cutting apparatus adapted to cut off each of series-connected packaged bags 21, which are made by inserting a material in a packaging film 2, heat sealing the resultant film, and thereby obtain continuously-formed packaged bags P, at a part to be cut off of each of lateral seal portions 2B with a pair of cutting members 81c, 82a. The cutting members 81c, 82a include the rotatably provided blade 81c, and the receiving blade 82a provided so as to be opposed to the rotatable blade 81c. Since the receiving blade 82a is provided with a transfer mechanism 83 adapted to be moved forward and rearward synchronously with a rotation of the rotary blade 81c, a portion swollen due to a packed material W of the series-connected packaged bags 21 does not contact the receiving blade 82a. This enables the series-connected packaged bags 21 to be transferred without hurting the film 2. Moreover, since the pulsation, which is ascribed to the contact of the bags with the receiving blade 82a, of the series-connected packaged bags 21, does not occur, the series-connected packaged bags 21 can be transferred stably, and the bags can be cut off accurately at the part to be cut off of each lateral seal portions 2B thereof.

The rotary blade 81c is provided so that the rotary blade cuts off a part to be cut off of each lateral seal portion 2B with an edge of the rotary blade inclined with respect to the direction in which the series-connected packaged bags 21 are fed. Therefore, the portion swollen due to the material W packed in each bag of the series-connected packaged bags 21 does not contact the rotary blade 81c in a locus (shown by a one-dot chain line in FIGS. 2 and 3) of the edge of the rotary blade 81c. This enables the bags to be transferred stably without hurting the film 2.

### BRIEF DESCRIPTION OF THE DRAWINGS

Preferred embodiments of the present invention will now be described with reference to the accompanying drawings, wherein:

FIG. 1 is a general plan view of a mode of embodiment of the present invention;

FIG. 2 is a partially sectioned plan view of a principal portion of what is shown in FIG. 1;

FIG. 3 is a partially sectioned plan view of a principal portion of what is shown in FIG. 1; and

FIG. 4 is a partially sectioned plan view of a principal portion of a cutting mechanism in another mode of embodiment.

### DESCRIPTION OF THE PREFERRED EMBODIMENTS

A cutting mechanism, to which the present invention is applied, provided as a mode of embodiment in a packaging machine is taken up as an example, and will be described by using the attached drawings.

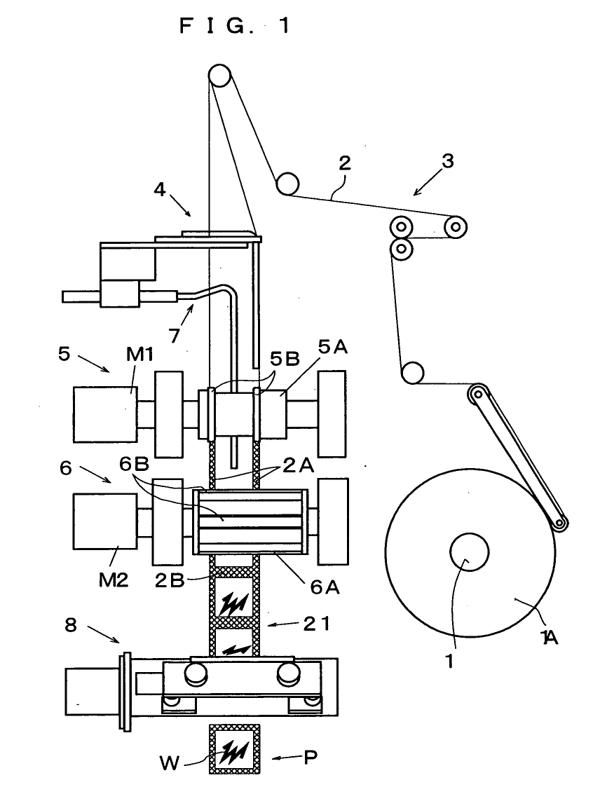

A general construction of a packaging machine will be described with reference to FIG. 1. The packaging machine is provided with a retaining frame 1, on which an original unprocessed film 1A obtained by winding a packaging film 2 into a roll is detachably and interchangeably mounted. The packaging machine is further provided for the purpose of packaging up a material (a material to be packaged) W in a sealed state with a film guide mechanism 3 and a film folding mechanism 4, a longitudinal sealing mechanism 5, a lateral sealing mechanism 6, a filling mechanism 7 and a cutting mechanism 8.

The film 2 is made at its seal portion forming parts, which will be described later, of a laminate of a transparent nylon film and a low-density polyethylene film, and drawn out from the original rolled unprocessed film 1A by the longitudinal sealing mechanism 5 constituting a feed mechanism for the film 2. The film 2 is then introduced in to the film folding mechanism 4 via the film guide mechanism 3, and folded in two in the longitudinal direction by a folding guide provided in the film folding mechanism 4. The film 2 is printed with registration marks (not shown) at predetermined intervals, and a feed speed of the film 2 is monitored by a registration mark detecting unit (not shown).

The longitudinal sealing mechanism 5 is provided so that the sealing mechanism 5 can be rotated by an operation of a driving unit Ml formed of a servomotor. The longitudinal sealing mechanism 5 is adapted to heat seal by longitudinal sealing plates 5B, which are mounted on outer circumferential surfaces of a pair of opposed longitudinal heat sealing rolls 5A, a folded base edge portion and a folded free edge portion (left and right edge portions) of the twofold film 2 while feeding the film 2, and thereby form longitudinal seal portions 2A. The two longitudinal heat sealing rolls 5A contain electric heaters (not shown) therein.

The lateral sealing mechanism 6 is provided so that the sealing mechanism 6 can be rotated by an operation of a driving unit M2 formed of a servomotor. The lateral sealing mechanism 6 is adapted to heat seal the film 2 in the lateral direction by lateral sealing plates 6B provided on a pair of opposed lateral heat sealing rolls 6A, and thereby form a bottom portion of a packaged bag P, i.e. a lateral seal portion (a joint seal portion) 2B. The two heat sealing rolls 6A contain electric heaters therein in the same manner as the rolls 5A in the longitudinal sealing mechanism 5.

The filling mechanism 7 is adapted to fill the interior of the film 2, which is formed to a continuous bottomed cylindrical shape by the longitudinal seal portions 2A and a lateral seal portion 2B, with a material W including a seasoning and soup containing solid, for example, sesame and pieces of meat. A bag-mouth portion of the film 2 containing this material W therein is further fed, heat sealed laterally again by the lateral sealing mechanism 6, and thereby put in a wholly sealed condition. Thus, series-connected packaged bags 21 in the form of longitudinally linked packages are formed.

The cutting mechanism 8 is adapted to cut off a substantially central part (which will hereinafter be referred to as a part to be cut off) of each of the lateral seal portions 2B of the series-connected packaged bags 21 with a pair of opposed cutting blades to obtain an independently separated packaged bag P.

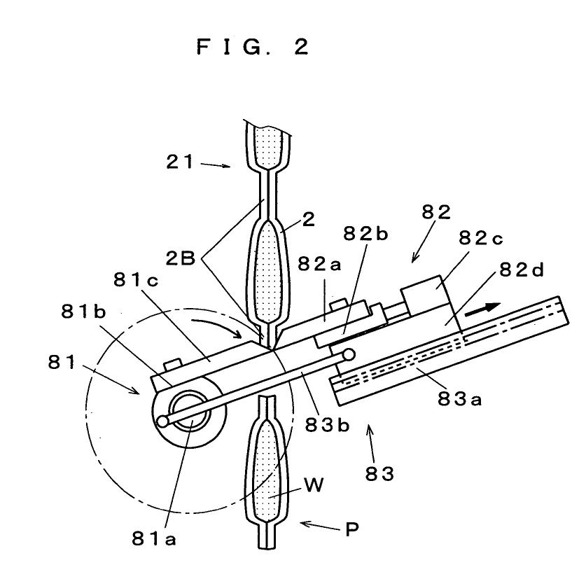

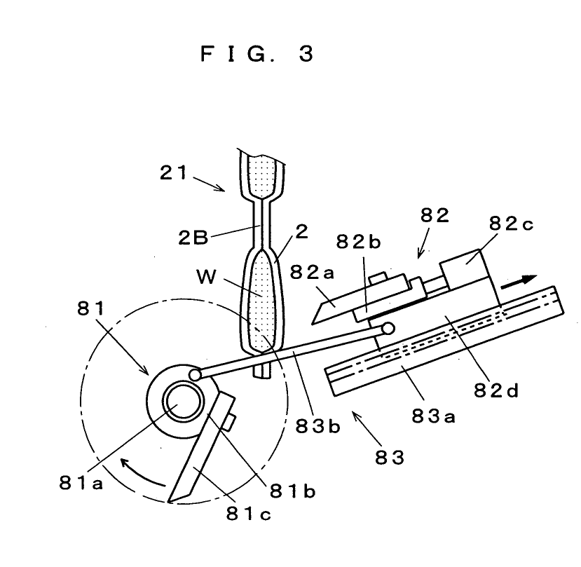

The cutting mechanism 8 constituting a main portion of the present invention will now be described in detail with reference to FIGS. 2 and 3. The cutting mechanism 8 includes mainly a rotary blade mechanism 81, a receiving blade mechanism 82, and a transfer mechanism 83.

The rotary blade mechanism 81 is formed by fixing via a mount portion 81b a rotary blade (cutting blade) 81c to an outer circumference of a rotary shaft 81a of a driving unit (not shown) made of a stepping motor or a servomotor. The rotary blade mechanism 81 is provided so that an edge of the rotary blade 81c contacts the part to be cut off of each of the lateral seal portions 2B with the edge of the rotary blade inclined toward an upstream side with respect to the direction in which the series-connected packaged bags 21 are fed.

The driving unit in the rotary blade mechanism 81 is adapted to make one turn of the rotary blade 81c within the production time per one packaged bag P which is determined on the basis of an arbitrarily set feed speed of the film 2 and the intervals of the lateral seal portions, and control the driving of the rotary blade so that the edge of the rotary blade contacts a part to be cut off of each lateral seal portion 2B of the bags continuously transferred. The controlling of the driving of this rotaray blade is done in the same manner as in the invention disclosed in JP-9-254910-A.

The receiving blade mechanism 82 includes mainly a receiving blade (cutting member) 82a, a support member 82b, a pressure member 82c and a base 82d. The receiving blade 82a is provided fixedly on the support member 82b so as to be opposed to the rotary blade 81c. The support member 82b is provided so that the support member can be slidingly moved with the receiving blade 82a along a guide (not shown) provided on the base 82d. The pressure member 82c is provided fixedly on the base 82d, and made of, for example, an air cylinder, which is adapted to press the support member 82b by an air pressure set by an air pressure regulator (not shown) and thereby keeps the receiving blade 82a stopped at an operation starting position. The base 82d is provided so that the base can be slidingly moved along a rail type guide which will be described later.

The transfer mechanism 83 includes a rail type guide 83a provided fixedly on a machine base (not shown) of the packaging machine and capable of moving the receiving blade mechanism 82 forward and rearward, and a link member 83b connected at one end thereof to the rotating portion of the rotary shaft, which is away from the axis of the rotary shaft 81a, and at the other end thereof to the base 82d. The transfer mechanism 83 is operated in accordance with a rotation of the rotary shaft 81a, and works (shown in FIG. 3) in the direction in which the base 82d leaves the rotary shaft 81a when the transfer mechanism is moved to a position of a top dead point with respect to the base 82d, and in the direction in which the rotary shaft 81a and base 82d come close to each other when the transfer mechanism is moved to a position of a lower dead point with respect to the base 82d. The transfer mechanism 83 is provided so that, when the transfer mechanism reaches the position of the lower dead point, the rotary blade 81c and receiving blade 82a are opposed to each other and can hold the part to be cut off of the lateral seal portion 2B. When the base 82d is moved forward and rearward, the receiving blade mechanism 82 as a whole is moved forward and rearward.

Such a packaging machine is a cutting apparatus adapted to cut with a pair of cutting blades 81c, 82a the parts to be cut off of the lateral seal portions 2B of series-connected packaged bags 21 produced by continuously forming packaged bags P, in which a material is sealed, by heat sealing the packaging film 2. The cutting blades 81c, 82a include a rotary blade 81c provided rotatably, and a receiving blade 82a provided so as to face the rotary blade 81c. The receiving blade 82a is provided with the transfer mechanism 83 moved forward and rearward synchronously with a rotation of the rotary blade 81c. Therefore, a swollen portion, which occurs due to the packed material W, of each of the series-connected packaged bags 21, does not contact the receiving blade 82a. This enables the series-connected packaged bags 21 to be transferred stably without hurting the film 2. Since the pulsation, which is ascribed to the swollen portion contacting the receiving blade 82a, of the series-connected packaged bags 21 does not occur, the packaged bags can be transferred stably, and the cutting of the part to be cut off of each lateral seal portion 2B to be done accurately.

The rotary blade 81c is provided so that the rotary blade cuts off the part to be cut off of each of the lateral seal portions 2B with the edge of the rotary blade inclined toward an upstream side with respect to the direction in which the series-connected packaged bags 21 are fed. Therefore, the portion swollen due to the packed material W of each of the series-connected packaged bags 21 does not contact the rotary blade 81c in a locus (shown by a one-dot chain line in FIGS. 2 and 3) of the edge of the rotary blade 81c. This enables the bags to be transferred stably without hurting the film 2.

The transfer mechanism 83 in the mode of embodiment of the present invention is transferred so as to move the receiving blade mechanism 82 forward and rearward by using the rail type guide 83a and link member 83b. According to the invention, the receiving blade 82a may be moved forward and rearward synchronously with a rotation of the rotary blade 81c, and the invention is not limited to the above-described mode of embodiment.

A transfer mechanism which does not use even such guide 83a and link member 83b as mentioned above, but which is adapted to move a receiving blade 82a forward and rearward by using, for example, a cam rotated synchronously with a rotation of the rotary shaft 81a, may be employed. A transfer mechanism in which a receiving blade 82a can be moved forward and rearward by using an air cylinder reciprocatingly movable by an operation for switching an electromagnetic valve capable of being switched in a predetermined cycle may also be employed.

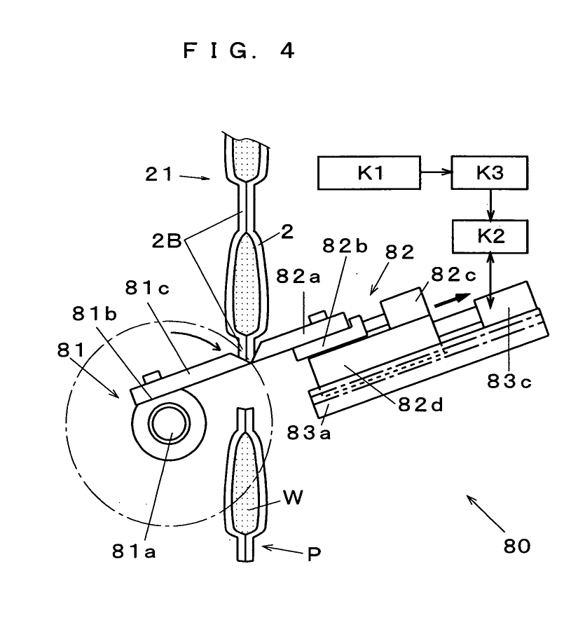

A cutting mechanism 80 in which a receiving blade 82a can be moved forward and rearward by a transfer mechanism using an air cylinder will be described (the parts of this cutting mechanism identical with those of the previously-described mode of embodiment are designated by the same reference numerals, and detailed description thereof is omitted) in detail by using FIG. 4. The transfer mechanism in the cutting mechanism 80 includes a detector K1 made of a photoelectric sensor and adapted to detect a rotational position of lateral seal plates 6B of a lateral heat sealing roll 6A, a rail type guide 83a, a cylinder 83c adapted to move forward and rearward a base 82d, which is provided on this guide 83a, with a receiving blade 82a, an electronic valve K2 adapted to switch a reciprocating movement of the cylinder 83c from one mode to the other on the basis of a control signal from a controller which will be described later, and a controller K3 formed of a microcomputer; having a ROM in which a program of a processing operation is stored, a RAM in which computed values are stored temporarily, a CPU for practicing the mentioned program, and an I/O interface for making electric connection with the detector K1 and electromagnetic valve K2; and adapted to operate the electromagnetic valve K2 at such time that is determined on the basis of a detected signal from the detector K1.

The controller K3 is adapted to calculate the time at which a part to be cut off of a lateral seal portion 2B of each of the series-connected packaged bags 21 passes the position in which a rotary blade 81c and a receiving blade 82a contact each other, on the basis of a detected signal from the detector K1, a speed of the film 2 fed from a longitudinal sealing mechanism 5, and a distance between the position of a lateral seal portion of a bag and the position in which the cutting blades 81c, 82a contact each other. The controller is also adapted to output a control signal for advancing a base 82d on a guide 83a to the electromagnetic valve K2 so that the rotary blade 81c and receiving blade 82a can contact each other at the mentioned time. The control unit K3 is also adapted to output into the electromagnetic valve K2 a control signal for promoting a rearward movement of the base 82d on the guide 83a to a position far behind an outer surface of a swollen part, which occurs due to the packed material W, of a packaged bag fed after the part to be cut off of the preceding packaged bag is cut off, in such a manner that the mentioned swollen part of the series-connected packaged bags 21 and the receiving blade 82a do not contact each other.

Therefore, this cutting mechanism is provided with the air cylinder 83c adapted to move the receiving blade 82a forward and rearward, electromagnetic valve K2 adapted to switch the reciprocating movements of the air cylinder 83 from one mode to the other, detector K1 adapted to detect the transfer condition of the series-connected packaged bags 21, and controller K3 adapted to calculate the time at which a part to be cut off of a joint seal portion 2B is cut off on the basis of a signal from the detector K1, advance the receiving blade 82a so that the receiving blade 82a and rotary blade 81c can contact each other at the mentioned time, and move back the receiving blade 82a after the mentioned time. This can prevent a swollen part, which occurs due to the packed material, of each of the series-connected packaged bags 21 from contacting the receiving blade 82a just as in the mode of embodiment using the link member 83b mentioned above, so that the series-connected packaged bags 21 can be transferred stably without hurting the film 2. Moreover, since the pulsation, which is ascribed to the contact of a swollen part with the receiving blade, of the series-connected packaged bags 21 does not occur, the series-connected packaged bags 21 can be transferred stably, and the parts to be cut off of the lateral seal portions 2B can be cut off accurately.

Although the cutting mechanism 8 in the modes of embodiment of the present invention for cutting off packaged bags is taken up as an example and described, the invention is not limited to this. The invention may also be applied to a partial cutting mechanism adapted to form a partial cutting line, for example, perforations in a part to be cut off of a lateral seal portion of each of series-connected packaged bags. In this packaging mechanism, the effect identical with those of the above-described embodiments is obtained.

As described above, the present invention relates to a cutting apparatus for cutting off predetermined parts of lateral seal portions, which are heat sealed by a lateral sealing mechanism, of series-connected packaged bags filled with a material continuously and packaged by sealing the bags longitudinally and laterally in three or four directions. The invention is suitably applied to, especially, a cutting apparatus adapted to stably transfer series-connected packaged bags having a large quantity of packed material and a large thickness, and accurately cut off these bags from one another.

What is claimed is:

1. A cutting apparatus adapted to cut off with a pair of cutting members a part to be cut off of each joint seal portion of series-connected packaged bags in which packaged bags containing a material sealed therein by heat sealing a packaging film are continuously formed, comprising cutting members formed of a rotatably provided blade, and a receiving blade provided so as to face the rotaryblade, the receiving blade being provided with a transfer mechanism adapted to be moved forward and rearward synchronously with a rotation of the rotary blade.

2. A cutting apparatus according to claim 1, wherein the rotary blade is provided so as to cut off the part to be cut off of each joint seal portion with an edge of the rotary blade inclined toward an upstream side with respect to the direction in which the series-connected packaged bags are fed.

3. A cutting apparatus according to claim 1, wherein the transfer mechanism includes an air cylinder adapted to move the receiving blade forward and rearward, an electromagnetic valve adapted to switch the reciprocating movements of the air cylinder from one mode to the other, a detector adapted to detect the transfer condition of the series-connected packaged bags, and a controller adapted to calculate the time at which a part to be cut off of each seal portion is cut off on the basis of a signal from the detector, and to control to the electromagnetic valve advance the receiving blade so that the receiving blade and rotary blade can contact each other at the mentioned time, and move back the receiving blade after the mentioned time.

4. A cutting apparatus according to claim 3, wherein the controller is adapted to control the electromagnetic valve so that the receiving blade is moved rearward after the mentioned seal portion cutting time to a position far behind an outer surface of a swollen part, which occurs due to the packed material, of the bag out of the series-connected packaged bags which is subsequently transferred to the seal portion cutting position.
